(19) United States
(12) Patent Application Publication
(10) Pub. No.: US 2025/0282634 A1
(43) Pub. Date: Sep. 11, 2025

(54) PROCESS FOR THE PREPARATION OF PARTICULATE ALUMINA

(71) Applicant: BASF Corporation, Florham Park, NJ (US)

(72) Inventors: Bernard REESINK, De Meern (NL); Bas BLEEKER, Utrecht (NL); Harry BOUWMAN, De Meern (NL); Robert TERORDE, De Meern (NL)

(21) Appl. No.: 18/859,578

(22) PCT Filed: Apr. 24, 2023
(86) PCT No.: PCT/EP2023/060617

§ 371 Date: Oct. 24, 2024

(30) Foreign Application Priority Data
Apr. 25, 2022 (EP) 22169779.0

(51) Int. Cl. C01F 7/14; B01J 21/04; B01J 35/31; B01J 35/40; B01J 35/61; B01J 35/63; B01J 37/00; B01J 37/08; C01F 7/441

(52) U.S. Cl. CPC C01F 7/14; B01J 21/04; B01J 35/31; B01J 35/40; B01J 35/613; B01J 35/615; B01J 35/635; B01J 35/638; B01J 37/0045; B01J 37/0072; B01J 37/08; C01F 7/441; C01P 2004/60; C01P 2006/10; C01P 2006/12; C01P 2006/14

(57) ABSTRACT

The present invention relates to a process for the preparation of particulate alumina, the process comprising (i) preparing a mixture comprising water and one or more sources of alumina; (ii) spraying the mixture for forming droplets; (iii) heating the droplets in a non-polar organic solvent system to a specific temperature, to obtain precursor particles; (iv) heating the precursor particles in an aqueous solution to a specific temperature, wherein the pH of said aqueous solution is adjusted to a value in the range of from 12 to 14. Further, the present invention relates to a particulate alumina as obtained and/or obtainable by said process. Yet further, the present invention relates to a particulate alumina having a side crushing strength in the range of from 9 to 25 N/mm and a packed apparent bulk density in the range of from 0.45 to 0.55 g/cm³ and use thereof.

### TECHNICAL FIELD

The present invention relates to a process for the preparation of particulate alumina. Further, the present invention relates to particulate alumina as such as well as particulate alumina obtained or obtainable according to said process and use thereof.

### INTRODUCTION

The selective hydrogenation of pyrolysis gas (pygas), or unsaturated C3-C4 hydrocarbons is commonly achieved using a catalytic material comprising a catalytically active metal supported on a support material. As catalytically active metal, usually one or more of Ni, Pd, and Pt are used. Thus, one or more of said metals are supported on the support material, usually via impregnation. As support material typically particulate alumina, often also designated as alumina spheres, are used. Several types of particulate alumina exist having different chemical and physical properties which may be chosen depending on the intended use.

Typically, a process for the preparation of particulate alumina starts with a source of alumina, e. g. rho-alumina, and deionized water which is mixed into a slurry. After that particulate alumina, in particular alumina spheres, are formed by spraying the slurry through a vibrating nozzle and they are solidified in a forming tower comprising oil. Then, the particulate alumina is transported with a water stream to an aging vessel which is heated to a temperature in the range of from 90 to 100° C. The particulate alumina stay therein for a certain time, e. g. for about 16 hours. Subsequently, the particulate alumina is washed to lower the sodium concentration. After that the particulate alumina is dried and calcined resulting in particulate alumina having a certain strength and surface area. Depending on the intended use, the particulate alumina can be loaded with a metal, e. g. nickel.

U.S. Pat. No. 7,090,825 B2 relates to alumina agglomerates and preparation method thereof. The preparation method includes dehydrating an aluminum oxyhydroxide or hydroxide, agglomerating the alumina thus obtained, hydrothermally treating the agglomerates and calcinating same. The obtained alumina agglomerates specifically have a volume occupied by the pores having a diameter greater than or equal to 37 Angstrom (V_{37 Å}) of greater than or equal to 75 ml/100 g, a volume occupied by the pores having a diameter greater than or equal to 0.1 micrometer (V_{0.1 micrometer}) of greater than or equal to 31 ml/100 g, and a volume occupied by the pores having a diameter greater than or equal to 0.2 micrometer (V_{0.2 micrometer}) of greater than or equal to 20 ml/100 g.

US 4,065,407 A relates to a process for the preparation of shaped particles from rehydratable alumina. In particular, a process is disclosed for preparing shaped alumina particles for catalysts or catalyst supports by passing droplets of an aqueous slurry of a rehydratable alumina composition through a shaping medium, such as a column of water-immiscible liquid, wherein the alumina composition undergoes rehydration while being shaped as it passes through the shaping medium, resulting in firm, discrete alumina bodies.

US 4,169,874 A relates to a process for the preparation of low density shaped alumina particles from rehydratable alumina. In particular, the process comprises introducing an aqueous slurry comprising water, an alumina containing a substantial portion of a rehydratable alumina, and a combustible filler to a shaping medium selected from (a) a water immiscible phase into which droplets of said alumina slurry are introduced to be shaped by surface tension forces into a spherical beaded form, and (b) tubing of desired cross sectional size and shape to shape said alumina into extrudate form, whereby the alumina is fashioned into a desired configuration, and applying heat to said shaping medium to rehydrate and harden the alumina while it is being sub-jected to the influence of the shaping medium.

US 6,197,073 B1 relates to a process for producing aluminum oxide beads. In particular, it is disclosed that an acid aluminum oxide sol or an acid aluminum oxide suspension is converted into droplets by a vibrating nozzle plate and pre-solidified after the formation of a bead shape by laterally blowing gaseous ammonia and then coagulated in an ammonia solution.

US 4,318,896 A relates to an alumina particle and a method for its manufacture. The method particularly comprises preparing a mixture of an acidic alumina hydrosol and an ammonia precursor at below gelation temperature, dispersing the mixture as droplets in a water-immiscible liquid at a temperature and for a time to effect at least partial gelation of the hydrosol to form hydrogel particles, contacting the hydrogel particles with a liquid having a pH no greater than about 7 and an osmotic pressure sufficient to prevent disintegration of the hydrogel particles, aging the hydrogel particles in an aqueous solution having a pH greater than 7, and thereafter drying and calcining the hydrogel particles.

US 4,542,113 A relates to a method for preparing spheroidal alumina. The method particularly comprises preparing an alumina sol having a solids content of more than 20 to 40% by weight of alumina from alumina hydrate, which consists of boehmite/pseudo-boehmite, by thorough stirring in aqueous dilute acid. Then, the alumina sol is caused in the presence of 1 to 10% by weight of urea to drop into a forming column whose top portion is filled with a liquid hydrocarbon and whose bottom portion is filled with an aqueous solution of ammonia and which is held at room temperature, and the thus formed spheroidal particles are dried and activated.

EP 0153674 A2 relates to rehydration bondable alumina. In particular, said document relates to low density alumina balls and a method for its production. Said method particularly comprises mixing rehydratable alumina powder with water to form a fluid slurry and mixing with a hot, immiscible fluid in such a way that the slurry is dispersed into droplets which become spherical due to surface tension effects, and then solidify by rehydration bonding.

US 3,223,483 A relates to a method of producing active alumina. In particular, the method of producing an alumina material particularly comprises calcining aluminum hydrate, agglomerating the calcined alumina by mixing with water, rehydrating the alumina agglomerates and heating said rehydrated agglomerates, only partially rehydrating said alumina agglomerates, and circulating water of low sodium content through the partially rehydrated alumina agglomerates to remove soluble sodium compounds therefrom and lower the sodium content thereof while continuing the rehydration of the partially rehydrated alumina agglomerates.

US 4,279,779 A relates to an alumina composition, a catalyst support comprising spheroidal alumina particles that may be prepared from the alumina composition, and a catalyst employing the alumina particles as a support. Further, it relates to processes for preparing alumina and spheroidal alumina particles.

US 4,411,771 A relates to improvements in alumina particles useful as catalyst supports and improved methods of making such particles and to improved hydrotreating catalysts comprising such particles as catalyst supports. The catalyst support particles are made from partially dehy-drated, rehydratable alumina which has been prepared by flash calcining hydrated alumina such as Bayer process alumina. In the process of forming shaped alumina particles, the partially de-hydrated alumina is rehydrated to set and harden the particles and then calcined to convert the alumina to essentially anhydrous alumina e.g. gamma and eta alumina.

US 4,315,839 A relates to a process for the preparation of spheroidal alumina particulates, which process is adapted for the preparation of very strong, lightweight, spheroidal alumina particulates having bifold porosity, without the necessity for having any pore-forming agent present in the starting mixture and without having to conduct any “aging” step.

US 10,232,346 B2 relates to the preparation of an amorphous mesoporous alumina shaped into beads by drop coagulation, starting from an alumina gel with a high dispersibility, said alumina gel being obtained by precipitation of at least one aluminium salt. In particular, it relates to a process for the preparation of said alumina by shaping an alumina gel, said alumina gel being prepared in accordance with a specific process for preparation by precipitation, in order to obtain at least 40% by weight of alumina with respect to the total quantity of alumina formed at the end of the gel preparation process, starting from the first precipitation step, the quantity of alumina formed at the end of the first precipitation step possibly even reaching 100%.

US 4,390,456 A relates to an alumina composition, a catalyst support comprising spheroidal alumina particles that may be prepared from the alumina composition, and a catalyst employing the alumina particles as a support.

There however remains a need for the provision of particulate alumina having an excellent physical integrity, in particular a comparatively high side crushing strength, as well as a comparatively low packed apparent bulk density. The particulate alumina should also be suitable as support for catalytically active metals. Thus, there remains a need for a novel process for the preparation of particulate alumina having said characteristics.

### DETAILED DESCRIPTION

Thus, it was an object of the present invention to provide a process for the preparation of particulate alumina, wherein the particulate alumina is particularly characterized by an excellent physical integrity. In particular, it was an object of the present invention to provide a process for the preparation of particulate alumina having a comparatively high side crushing strength and a comparatively low packed apparent bulk density. Yet further, it was an object of the present invention to provide a particulate alumina being characterized in particular by a comparatively high side crushing strength and a comparatively low packed apparent bulk density.

Surprisingly, it has been found that particulate alumina can be prepared according to a novel process, whereby the obtained particulate alumina has specific characteristics, in particular a comparatively high side crushing strength and a comparatively low packed apparent bulk density. In particular, it has been surprisingly found that a novel process can be provided for the preparation of such a particulate alumina wherein especially the pH of the aqueous solution in which the particulate alumina is aged is adjusted to a value in the range of from 12 to 14. Thereby, particulate alumina can be prepared having a comparatively high side crushing strength as well as a comparatively low packed apparent bulk density.

Therefore, the present invention relates to a process for the preparation of particulate alumina, comprising:
(i) preparing a mixture comprising water and one or more sources of alumina;
(ii) spraying the mixture obtained in (i) for forming droplets;
(iii) heating the droplets obtained in (ii) in a non-polar organic solvent system, to a temperature in the range of from 85 to 100° C., to obtain precursor particles;
(iv) heating the precursor particles obtained in (iii) in an aqueous solution S2 to a temperature in the range of from 85 to 110° C., wherein the pH of the aqueous solution S2 is in the range of from 12 to 14, to obtain particulate alumina.

It is preferred that preparing the mixture in (i) comprises cooling the mixture to a temperature in the range of from 0 to 15° C., more preferably in the range of from 2 to 10° C., more preferably in the range of from 3 to 7° C.

It is preferred that (i) comprises
(i.1) cooling water to a temperature in the range of from 0 to 15° C., preferably in the range of from 2 to 10° C., more preferably in the range of from 3 to 7° C.;
(i.2) mixing one or more sources of alumina with the water cooled in (i.1); to obtain the mixture comprising water and the one or more sources of alumina.

It is preferred that preparing the mixture in (i) comprises stirring, more preferably stirring with a helix stirrer, wherein preparing the mixture in (i) more preferably comprises stirring at 200 to 300 rpm, more preferably at 225 to 275 rpm.

It is preferred that the total amount of the one or more sources of alumina in the mixture obtained in (i) calculated as Al₂O₃ is in the range of from 40 to 65 weight-%, more preferably in the range of from 45 to 60 weight-%, more preferably in the range of from 50 to 55 weight-%, more preferably in the range of from 52 to 53 weight-%, based on the weight of the mixture obtained in (i).

It is preferred that the one or more sources of alumina comprise, preferably consist of, one or more of aluminum trihydroxide, Al₂O₃·0.5 H₂O, rho-alumina, and sodium aluminate, more preferably one or more of gibbsite (alpha-aluminum trihydroxide), bayerite (beta-aluminum trihydroxide), nordstrandite (gamma-aluminum trihydroxide), pseudoamorphous aluminum trihydroxide, Al₂O₃·0.5 H₂O, rho-alumina, and sodium aluminate, wherein the one or more sources of alumina more preferably comprise, more preferably consist of, one or more of sodium aluminate, Al₂O₃·0.5 H₂O and rho-alumina.

Rho alumina is also known as hydratable or re-hydratable alumina.

By varying addition of NaAlO₂ the viscosity of the mixture can be influenced. Typically, the viscosity slowly increases due to re-hydration of the used alumina. This increase can be reduced or the viscosity kept constant for a prolonged time to allow processing a batch of slurry during 4-8 hours.

Thus, it is preferred that the one or more sources of alumina comprises sodium aluminate, and that preparing the mixture according to (i) comprises adding an aqueous sodium aluminate solution in an amount in the range of from 0.05 to 1.5 volume-%, more preferably in the range of from 0.1 to 1.0 volume-%, based on the volume of the mixture obtained in (i).

In the case where the one or more sources of alumina comprise sodium aluminate, and wherein preparing the mixture according to (i) comprises adding an aqueous sodium aluminate solution in an amount in the range of from 0.05 to 1.5 volume-%, preferably in the range of from 0.1 to 1.0 volume-%, based on the volume of the mixture obtained in (i), it is preferred that the aqueous sodium aluminate solution comprises from 32 to 44 weight-%, more preferably from 36 to 40 weight-%, more preferably from 37 to 39 weight-%, of sodium aluminate, based on the weight of the aqueous sodium aluminate solution.

It is preferred that the one or more sources of alumina contained in the mixture obtained in (i) are milled, more preferably ball-milled, hammer-milled or jet-milled, more preferably ball-milled.

It is preferred that one or more of the one or more sources of alumina contained in the mixture obtained in (i) are solid, wherein said one or more solid sources of alumina in the mixture obtained in (i) have a D50 value of the volume-based particle size in the range of from 1 to 11 micrometer, more preferably in the range of from 2 to 8 micrometer, more preferably in the range of from 3 to 7 micrometer, preferably determined according to Reference Example 7.

It is preferred that the mixture obtained in (i) has a viscosity in the range of from 700 to 900 mPa·s, more preferably in the range of from 750 to 850 mPa·s, more preferably in the range of from 790 to 810 mPa·s.

It is preferred that the mixture obtained in (i) comprises an amount of sodium hydroxide in the range of from 0 to 1 mol-%, more preferably in the range of from 0 to 0.1 mol-%, preferably in the range of from 0 to 0.01 mol-%, based on the total amount of the one or more sources of alumina calculated as Al₂O₃.

It is preferred that the mixture obtained in (i) is sprayed in (ii) by means of a nozzle, preferably under vibration of the nozzle.

In the case where the mixture obtained in (i) is sprayed in (ii) by means of a nozzle, preferably under vibration of the nozzle, it is preferred that the nozzle comprises an aperture having a diameter in the range of from 1.0 to 1.4 mm, more preferably in the range of from 1.1 to 1.3 mm.

Further in the case where the mixture obtained in (i) is sprayed in (ii) by means of a nozzle, preferably under vibration of the nozzle, it is preferred that the nozzle is arranged to allow spraying the mixture obtained in (i) in the direction of fall of the formed droplets.

It is preferred that the mixture obtained in (i) is sprayed according to (ii) by means of the nozzle with a frequency in the range of 1 to 5 droplets per s, more preferably in the range of from 1 to 3 droplets per s.

It is preferred that the mixture obtained in (i) is sprayed according to (ii) by means of the nozzle to obtain droplets having an average diameter in the range of from 1 to 5 mm, more preferably in the range of from 2 to 4 mm, more preferably in the range of from 2.5 to 3.5 mm.

It is preferred that spraying the mixture obtained in (i) according to (ii) comprises applying a flow rate in the range of from 50 to 80 cm³/min, more preferably in the range of from 55 to 75 cm³/min, more preferably in the range of from 60 to 70 cm³/min.

It is preferred that spraying the mixture obtained in (i) according to (ii) comprises applying an overpressure in the range of from 0.1 to 0.8 bar, more preferably in the range of from 0.2 to 0.7 bar, more preferably in the range of from 0.3 to 0.6 bar.

It is preferred that the process further comprises after (ii) and prior to (iii) allowing the droplets obtained in (ii) to fall through a gas atmosphere, wherein the gas atmosphere has a temperature in the range of from 10 to 60° C., preferably in the range of from 15 to 50° C., wherein the gas atmosphere more preferably comprises one or more of nitrogen and oxygen, wherein the gas atmosphere more preferably is air.

It is preferred that the droplets obtained in (ii) are heated in (iii) for a duration in the range of from 10 to 50 s, more preferably in the range of from 14 to 40 s, more preferably in the range of from 15 to 30 s, more preferably in the range of from 20 to 25 s, more preferably in the range of from 21 to 22 s.

It is preferred that the droplets obtained in (ii) are heated in (iii) to a temperature in the range of from 90 to 98° C., more preferably in the range of from 94 to 96° C.

It is preferred that the droplets obtained in (ii) are heated in (iii) in a column.

In the case where the droplets obtained in (ii) are heated in (iii) in a column, it is preferred that the column has a length in the range of from 0.5 to 5 m, more preferably in the range of from 1 to 4 m, more preferably in the range of from 2 to 3 m.

Further in the case where the droplets obtained in (ii) are heated in (iii) in a column, it is preferred that the column has a diameter in the range of from 30 to 70 mm, preferably in the range of from 45 to 55 mm.

It is preferred that heating the droplets obtained in (ii) according to (iii) comprises maintaining the droplets in suspense in a non-polar organic solvent, preferably by allowing the droplets to fall through the non-polar organic solvent system.

It is preferred that the non-polar organic solvent system comprises an amount in the range of from 0 to 0.2 weight-%, more preferably in the range of from 0 to 0.1 weight-%, of S, based on the weight of the non-polar organic solvent system, wherein the amount of S is preferably determined according to DIN EN ISO 14596.

It is preferred that the non-polar organic solvent system has a density in the range of from 850 to 880 g/ml, more preferably in the range of from 860 to 870 g/ml, wherein the density is preferably determined at a temperature of 20° C., wherein the density is more preferably determined according to DIN 51757 test procedure 3 (German DIN 51757 Verf. 3).

It is preferred that the non-polar organic solvent system has a kinetic viscosity in the range of from 4.8 to 5.6 mm²/s, more preferably in the range of from 5.0 to 5.4 mm²/s, wherein the kinetic viscosity is preferably determined at a temperature of 100° C., wherein the kinetic viscosity is more preferably determined according to DIN EN ISO 3104.

It is preferred that the non-polar organic solvent system has a refractive index in the range of from 1.4763 to 1.4769, more preferably in the range of from 1.4765 to 1.4767, wherein the refractive index is preferably determined at a temperature of 100° C., wherein the refractive index is more preferably determined according to DIN 51423-02.

It is preferred that the non-polar organic solvent system comprises an amount in the range of from 2 to 4 weight-%, more preferably in the range of from 2.5 to 3.5 weight-%, of aromatic hydrocarbons, based on the weight of the non-polar organic solvent system, wherein the amount of aromatic hydrocarbons is preferably determined according to calculation method U of DIN 51378.

It is preferred that the non-polar organic solvent system comprises an amount in the range of from 28 to 34 weight-%, more preferably in the range of from 30 to 32 weight-%, of naphthenic hydrocarbons, based on the weight of the non-polar organic solvent system, wherein the amount of naphthenic hydrocarbons is preferably determined according to calculation method U of DIN 51378.

It is preferred that the non-polar organic solvent system comprises an amount in the range of from 61 to 69 weight-%, more preferably in the range of from 63 to 67 weight-%, of paraffinic hydrocarbons, based on the weight of the non-polar organic solvent system, wherein the amount of paraffinic hydrocarbons is preferably determined according to calculation method U of DIN 51378.

It is preferred that the non-polar organic solvent system has a viscosity index in the range of from 97 to 103, more preferably in the range of from 99 to 101, wherein the viscosity index is preferably determined according to DIN ISO 2909.

It is preferred that heating the droplets obtained in (ii) according to (iii) comprises applying a flow of the non-polar organic solvent system opposite to the falling direction of the droplets.

It is preferred that the process further comprises after (iii) and prior to (iv) collecting the precursor particles in an aqueous solution S₁.

In the case where the process further comprises after (iii) and prior to (iv) collecting the precursor particles in an aqueous solution S₁, it is preferred that the pH of the aqueous solution S₁ is in the range of from 11.0 to 14.0, more preferably in the range of from 12.0 to 13.7, more preferably in the range of from 13.0 to 13.5.

Further in the case where the process further comprises after (iii) and prior to (iv) collecting the precursor particles in an aqueous solution S₁, it is preferred that the precursor particles are collected in the aqueous solution S₁ in a column, wherein the precursor particles are more preferably collected in the same column in which the droplets obtained in (ii) are heated according to (iii).

Further in the case where the process further comprises after (iii) and prior to (iv) collecting the precursor particles in an aqueous solution S₁, it is preferred that heating the droplets obtained in (ii) in a non-polar organic solvent system according to (iii) and collecting the droplets in an aqueous solution S₁ is performed in a column, wherein the column comprises the non-polar organic solvent system and the aqueous solution S₁,
wherein the droplets obtained in (ii) are heated according to (iii) prior to being collected in the aqueous solution S₁,
wherein the process preferably comprises allowing the droplets obtained in (ii) to pass through the non-polar-organic solvent system prior to being collected in the aqueous solution S₁.

It is preferred that the precursor particles obtained in (iii) are heated in the aqueous solution S₂ according to (iv) in a vessel.

It is preferred that the weight ratio of the precursor particles, calculated as sum of the weights of the precursor particles, to the aqueous solution S₂, calculated as weight of the aqueous solution S₂, in (iv) is in the range of from 1:2 to 1:20, more preferably in the range of from 1:4 to 1:15, more preferably in the range of from 1:6 to 1:10.

It is preferred that the aqueous solution S₂ comprises one or more of sodium aluminate (NaAlO₂), ammonia, and sodium hydroxide (NaOH), more preferably sodium aluminate (NaAlO₂) and sodium hydroxide.

In the case where the aqueous solution S₂ comprises one or more of sodium aluminate (NaAlO₂), ammonia, and sodium hydroxide (NaOH), more preferably sodium aluminate (NaAlO₂) and sodium hydroxide, it is preferred that the aqueous solution S₂ comprises aluminum, in addition to the aluminum comprised in the precursor particles, calculated as Al₂O₃, in an amount in the range of from 3.00 to 6.50 g/l, more preferably in the range of from 4.50 to 5.00 g/l, more preferably in the range of from 4.65 to 4.80 g/l.

Further in the case where the aqueous solution S₂ comprises one or more of sodium aluminate (NaAlO₂), ammonia, and sodium hydroxide (NaOH), more preferably sodium aluminate (NaAlO₂) and sodium hydroxide, it is preferred that the aqueous solution S₂ comprises sodium, in addition to the sodium optionally comprised in the precursor particles, calculated as Na, in an amount in the range of from 2.00 to 5.00 g/l, more preferably in the range of from 3.40 to 3.80 g/l, more preferably in the range of from 3.55 to 3.65 g/l.

It is preferred that the pH of the aqueous solution S₂ according to (iv) is in the range of from 12.2 to 13.9, more preferably in the range of from 12.4 to 13.8, more preferably in the range of from 12.6 to 13.7, more preferably in the range of from 12.8 to 13.6, more preferably in the range of from 13.0 to 13.5, wherein the pH is preferably determined according to Reference Example 1.

It is preferred that the precursor particles obtained in (iii) are heated according to (iv) to a temperature in the range of from 87 to 105° C., more preferably in the range of from 89 to 102° C., more preferably in the range of from 90 to 100° C.

It is preferred that the precursor particles obtained in (iii) are heated according to (iv) for a duration in the range of from 3 to 25 h, more preferably in the range of from 4 to 20 h, more preferably in the range of from 5 to 17 h.

It is preferred that the process further comprises
(v) separating the particulate alumina obtained in (iv) from the aqueous solution S₂, wherein separating preferably comprises filtration or centrifugation of the aqueous solution S₂.

It is preferred that the process further comprises
(vi) washing the particulate alumina obtained in (iv) or (v) with a liquid solvent system, wherein the liquid solvent system preferably comprises one or more of water, an alcohol, and a mixture of two or more thereof, wherein the particulate alumina is more preferably washed with water, wherein the particulate alumina is more preferably washed with de-ionized water, wherein the particulate alumina is more preferably washed with de-ionized water until the conductivity of the washing water was less than 400 microS.

It is preferred that the process further comprises
(vii) drying of the particulate alumina obtained in (iv), (v) or (vi) in a gas atmosphere.

In the case where the process further comprises drying of the particulate alumina obtained in (iv), (v) or (vi) in a gas atmosphere according to (vii), it is preferred that the gas atmosphere in (vii) has a temperature in the range of from 90 to 130° C., more preferably in the range of from 100 to 120° C., more preferably in the range of from 105 to 115° C.

Further in the case where the process further comprises drying of the particulate alumina obtained in (iv), (v) or (vi) in a gas atmosphere according to (vii), it is preferred that the gas atmosphere in (vii) comprises one or more of oxygen and nitrogen, wherein the gas atmosphere in (vii) more preferably is oxygen or air.

Further in the case where the process further comprises drying of the particulate alumina obtained in (iv), (v) or (vi) in a gas atmosphere according to (vii), it is preferred that the particulate alumina obtained in (iv), (v) or (vi) is dried in (vii) in an oven or in a belt dryer, more preferably in a belt dryer.

Further in the case where the process further comprises drying of the particulate alumina obtained in (iv), (v) or (vi) in a gas atmosphere according to (vii), it is preferred that the particulate alumina obtained in (iv), (v) or (vi) is dried in (vii) for 1 to 5 h, more preferably for 2 to 3 h.

It is preferred that the process further comprises
(viii) pre-calcining of the particulate alumina obtained in (iv), (v), (vi) or (vii) in a gas atmosphere.

In the case where the process further comprises pre-calcining of the particulate alumina obtained in (iv), (v), (vi) or (vii) in a gas atmosphere according to (viii), it is preferred that the gas atmosphere in (viii) has a temperature in the range of from 400 to 460° C., more preferably in the range of from 420 to 440° C., more preferably in the range of from 425 to 435° C.

Further in the case where the process further comprises pre-calcining of the particulate alumina obtained in (iv), (v), (vi) or (vii) in a gas atmosphere according to (viii), it is preferred that pre-calcining according to (viii) comprises heating of the gas atmosphere with a heating ramp of 3 to 7 K/min, more preferably of 4 to 6 K/min.

Further in the case where the process further comprises pre-calcining of the particulate alumina obtained in (iv), (v), (vi) or (vii) in a gas atmosphere according to (viii), it is preferred that the gas atmosphere in (viii) comprises one or more of oxygen and nitrogen, wherein the gas atmosphere in (viii) more preferably is oxygen or air.

Further in the case where the process further comprises pre-calcining of the particulate alumina obtained in (iv), (v), (vi) or (vii) in a gas atmosphere according to (viii), it is preferred that the particulate alumina obtained in (iv), (v), (vi) or (vii) is pre-calcined in (viii) in a rotary calciner.

Further in the case where the process further comprises pre-calcining of the particulate alumina obtained in (iv), (v), (vi) or (vii) in a gas atmosphere according to (viii), it is preferred that the particulate alumina obtained in (iv), (v), (vi) or (vii) is pre-calcined in (viii) for 0.25 to 2 h, more preferably for 0.5 to 1 h.

It is preferred that the process further comprises
(ix) calcining of the particulate alumina obtained in (iv), (v), (vi), (vii) or (viii) in a gas atmosphere.

In the case where the process further comprises calcining of the particulate alumina obtained in (iv), (v), (vi), (vii) or (viii) in a gas atmosphere according to (ix), it is preferred that the gas atmosphere in (ix) has a temperature in the range of from 900 to 1050° C., more preferably in the range of from 940 to 980° C., more preferably in the range of from 945 to 975° C.

Further in the case where the process further comprises calcining of the particulate alumina obtained in (iv), (v), (vi), (vii) or (viii) in a gas atmosphere according to (ix), it is preferred that calcining according to (ix) comprises heating of the gas atmosphere with a heating ramp of 3 to 7 K/min, more preferably of 4 to 6 K/min.

Further in the case where the process further comprises calcining of the particulate alumina obtained in (iv), (v), (vi), (vii) or (viii) in a gas atmosphere according to (ix), it is preferred that the gas atmosphere in (ix) comprises one or more of oxygen and nitrogen, wherein the gas atmosphere in (ix) more preferably is oxygen or air.

Further in the case where the process further comprises calcining of the particulate alumina obtained in (iv), (v), (vi), (vii) or (viii) in a gas atmosphere according to (ix), it is preferred that the particulate alumina obtained in (iv), (v), (vi), (vii) or (viii) is calcined in (ix) in a rotary calciner.

Further in the case where the process further comprises calcining of the particulate alumina obtained in (iv), (v), (vi), (vii) or (viii) in a gas atmosphere according to (ix), it is preferred that the particulate alumina obtained in (iv), (v), (vi), (vii) or (viii) is calcined in (ix) for 0.25 to 2 h, more preferably for 0.5 to 1 h.

Further, the present invention relates to a particulate alumina as obtained and/or obtainable by the process according to any one of the embodiments disclosed herein.

It is preferred that the particulate alumina has a side crushing strength in the range of from 9 to 25 N/mm, more preferably in the range of from 10 to 19 N/mm, more preferably in the range of from 11 to 18 N/mm, more preferably in the range of from 12 to 17 N/mm, preferably determined according to Reference example 2.

It is preferred that the particulate alumina has a particle diameter in the range of from 2.0 to 3.0 mm, more preferably in the range of from 2.5 to 3.0 mm, preferably according to Reference example 6.

It is preferred that the particulate alumina has a packed apparent bulk density in the range of from 0.45 to 0.55 g/cm³, more preferably in the range of from 0.48 to 0.52 g/cm³, more preferably in the range of from 0.49 to 0.51 g/cm³, preferably determined according to Reference example 3.

It is preferred that the particulate alumina comprises an amount of Na, calculated as elemental Na, in the range of from 0 to 25000 ppm, more preferably in the range of from 0 to 20000 ppm, preferably determined according to Reference Example 8.

It is preferred that the particulate alumina has a BET specific surface area in the range of from 30 to 150 m²/g, preferably in the range of from 40 to 140 m²/g, preferably determined according to Reference Example 4.

It is preferred that the particulate alumina has a total pore volume in the range of from 0.5 to 1.5 ml/g, more preferably in the range of from 0.7 to 1.3 ml/g, more preferably in the range of from 0.8 to 1.2 ml/g, preferably determined according to Reference Example 5.

It is preferred that the particulate alumina has a relative particle attrition in the range of from 0 to 2 weight-%, preferably determined according to Reference Example 9.

It is preferred that the particulate alumina is in the form of a sphere.

Yet further, the present invention relates to a particulate alumina having a side crushing strength in the range of from 9 to 25 N/mm and a packed apparent bulk density in the range of from 0.45 to 0.55 g/cm³, wherein the side crushing strength is preferably determined according to Reference Example 2, and wherein the packed apparent bulk density is preferably determined according to Reference Example 3.

It is preferred that the particulate alumina has a side crushing strength in the range of from 10 to 19 N/mm, more preferably in the range of from 11 to 18 N/mm, more preferably in the range of from 12 to 17 N/mm, preferably determined according to Reference example 2.

It is preferred that the particulate alumina has a particle diameter in the range of from 2.0 to 3.0 mm, more preferably in the range of from 2.5 to 3.0 mm, preferably according to Reference example 6.

It is preferred that the particulate alumina has a packed apparent bulk density in the range of from 0.48 to 0.52 g/cm³, more preferably in the range of from 0.49 to 0.51 g/cm³, preferably determined according to Reference example 3.

It is preferred that the particulate alumina comprises an amount of Na, calculated as elemental Na, in the range of from 0 to 25000 ppm, more preferably in the range of from 0 to 20000 ppm.

It is preferred that the particulate alumina has a BET specific surface area in the range of from 30 to 150 m²/g, more preferably in the range of from 40 to 140 m²/g, preferably determined according to Reference Example 4.

It is preferred that the particulate alumina has a total pore volume in the range of from 0.5 to 1.5 ml/g, more preferably in the range of from 0.7 to 1.3 ml/g, more preferably in the range of from 0.8 to 1.2 ml/g, preferably determined according to Reference Example 5.

It is preferred that the particulate alumina has a relative particle attrition in the range of from 0 to 2 weight-%, preferably determined according to Reference Example 9.

It is preferred that the particulate alumina is in the form of a sphere.

Yet further, the present invention relates to a use of an particulate alumina according to any one of the embodiments disclosed herein as a catalyst or catalyst support, preferably as a catalyst support for a metal selected from the group consisting of Fe, Ru, Os, Co, Rh, Ir, Ni, Pd, Pt, Cu, Ag, Au, and a mixture of two or more thereof, more preferably as a catalyst support for a metal selected from the group consisting of Pd, Ag, and a mixture thereof.

The present invention is further illustrated by the following set of embodiments and combinations of embodiments resulting from the dependencies and back-references as indicated. In particular, it is noted that in each instance where a range of embodiments is mentioned, for example in the context of a term such as “The process of any one of embodiments 1 to 4”, every embodiment in this range is meant to be explicitly disclosed for the skilled person, i.e. the wording of this term is to be understood by the skilled person as being synonymous to “The process of any one of embodiments 1, 2, 3, and 4”.

Further, it is explicitly noted that the following set of embodiments is not the set of claims determining the extent of protection, but represents a suitably structured part of the description di-rected to general and preferred aspects of the present invention.

1. A process for the preparation of particulate alumina, comprising:
(i) preparing a mixture comprising water and one or more sources of alumina;
(ii) spraying the mixture obtained in (i) for forming droplets;
(iii) heating the droplets obtained in (ii) in a non-polar organic solvent system, to a temperature in the range of from 85 to 100° C., to obtain precursor particles;
(iv) heating the precursor particles obtained in (iii) in an aqueous solution S₂ to a temperature in the range of from 85 to 110° C., wherein the pH of the aqueous solution S₂ is in the range of from 12 to 14, to obtain particulate alumina.

2. The process according to embodiment 1, wherein preparing the mixture in (i) comprises cooling the mixture to a temperature in the range of from 0 to 15° C., preferably in the range of from 2 to 10° C., more preferably in the range of from 3 to 7° C.

3. The process according to embodiment 1 or 2, wherein (i) comprises
(i.1) cooling water to a temperature in the range of from 0 to 15° C., preferably in the range of from 2 to 10° C., more preferably in the range of from 3 to 7° C.;
(i.2) mixing one or more sources of alumina with the water cooled in (i.1); to obtain the mixture comprising water and the one or more sources of alumina.

4. The process according to any one of embodiments 1 to 3, wherein preparing the mixture in (i) comprises stirring, preferably stirring with a helix stirrer, wherein preparing the mixture in (i) preferably comprises stirring at 200 to 300 rpm, more preferably at 225 to 275 rpm.

5. The process according to any one of embodiments 1 to 4, wherein the total amount of the one or more sources of alumina in the mixture obtained in (i) calculated as Al₂O₃ is in the range of from 40 to 65 weight-%, preferably in the range of from 45 to 60 weight-%, more preferably in the range of from 50 to 55 weight-%, more preferably in the range of from 52 to 53 weight-%, based on the weight of the mixture obtained in (i).

6. The process according to any one of embodiments 1 to 6, wherein the one or more sources of alumina comprise, preferably consist of, one or more of aluminum trihydroxide, Al₂O₃·0.5 H₂O, rho-alumina, and sodium aluminate, preferably one or more of gibbsite (alpha-aluminum trihydroxide), bayerite (beta-aluminum trihydroxide), nordstrandite (gamma-aluminum trihydroxide), pseudoamorphous aluminum trihydroxide, Al₂O₃·0.5 H₂O, rho-alumina, and sodium aluminate, wherein the one or more sources of alumina more preferably comprise, more preferably consist of, one or more of sodium aluminate, Al₂O₃·0.5 H₂O and rho-alumina.

7. The process according to any one of embodiments 1 to 6, wherein the one or more sources of alumina comprise sodium aluminate, and wherein preparing the mixture according to (i) comprises adding an aqueous sodium aluminate solution in an amount in the range of from 0.05 to 1.5 volume-%, preferably in the range of from 0.1 to 1.0 volume-%, based on the volume of the mixture obtained in (i).

8. The process according to embodiment 7, wherein the aqueous sodium aluminate solution comprises from 32 to 44 weight-%, preferably from 36 to 40 weight-%, more preferably from 37 to 39 weight-%, of sodium aluminate, based on the weight of the aqueous sodium aluminate solution.

9. The process according to any one of embodiments 1 to 8, wherein the one or more sources of alumina contained in the mixture obtained in (i) are milled, preferably ball-milled, hammer-milled or jet-milled, more preferably ball-milled.

10. The process according to any one of embodiments 1 to 9, wherein one or more of the one or more sources of alumina contained in the mixture obtained in (i) are solid, wherein said one or more solid sources of alumina in the mixture obtained in (i) have a D50 value of the volume-based particle size in the range of from 1 to 11 micrometer, preferably in the range of from 2 to 8 micrometer, more preferably in the range of from 3 to 7 micrometer, preferably determined according to Reference Example 7.

11. The process according to any one of embodiments 1 to 10, wherein the mixture obtained in (i) has a viscosity in the range of from 700 to 900 mPa·s, preferably in the range of from 750 to 850 mPa·s, more preferably in the range of from 790 to 810 mPa·s.

12. The process according to any one of embodiments 1 to 11, wherein the mixture obtained in (i) comprises an amount of sodium hydroxide in the range of from 0 to 1 mol-%, preferably in the range of from 0 to 0.1 mol-%, preferably in the range of from 0 to 0.01 mol-%, based on the total amount of the one or more sources of alumina calculated as Al₂O₃.

13. The process according to any one of embodiments 1 to 12, wherein the mixture obtained in (i) is sprayed in (ii) by means of a nozzle, preferably under vibration of the nozzle.

14. The process according to embodiment 13, wherein the nozzle comprises an aperture having a diameter in the range of from 1.0 to 1.4 mm, preferably in the range of from 1.1 to 1.3 mm.

15. The process according to embodiment 13 or 14, wherein the nozzle is arranged to allow spraying the mixture obtained in (i) in the direction of fall of the formed droplets.

16. The process according to any one of embodiments 1 to 15, wherein the mixture obtained in (i) is sprayed according to (ii) by means of the nozzle with a frequency in the range of 1 to 5 droplets per s, preferably in the range of from 1 to 3 droplets per s.

17. The process according to any one of embodiments 1 to 16, wherein the mixture obtained in (i) is sprayed according to (ii) by means of the nozzle to obtain droplets having an average diameter in the range of from 1 to 5 mm, preferably in the range of from 2 to 4 mm, more preferably in the range of from 2.5 to 3.5 mm.

18. The process according to any one of embodiments 1 to 17, wherein spraying the mixture obtained in (i) according to (ii) comprises applying a flow rate in the range of from 50 to 80 cm³/min, preferably in the range of from 55 to 75 cm³/min, more preferably in the range of from 60 to 70 cm³/min.

19. The process according to any one of embodiments 1 to 18, wherein spraying the mixture obtained in (i) according to (ii) comprises applying an overpressure in the range of from 0.1 to 0.8 bar, preferably in the range of from 0.2 to 0.7 bar, more preferably in the range of from 0.3 to 0.6 bar.

20. The process according to any one of embodiments 1 to 19, wherein the process further comprises after (ii) and prior to (iii) allowing the droplets obtained in (ii) to fall through a gas atmosphere, wherein the gas atmosphere has a temperature in the range of from 10 to 60° C., preferably in the range of from 15 to 50° C., wherein the gas atmosphere preferably comprises one or more of nitrogen and oxygen, wherein the gas atmosphere more preferably is air.

21. The process according to any one of embodiments 1 to 20, wherein the droplets obtained in (ii) are heated in (iii) for a duration in the range of from 10 to 50 s, preferably in the range of from 14 to 40 s, more preferably in the range of from 15 to 30 s, more preferably in the range of from 20 to 25 s, more preferably in the range of from 21 to 22 s.

22. The process according to any one of embodiments 1 to 21, wherein the droplets obtained in (ii) are heated in (iii) to a temperature in the range of from 90 to 98° C., preferably in the range of from 94 to 96° C.

23. The process according to any one of embodiments 1 to 22, wherein the droplets obtained in (ii) are heated in (iii) in a column.

24. The process according to embodiment 23, wherein the column has a length in the range of from 0.5 to 5 m, preferably in the range of from 1 to 4 m, more preferably in the range of from 2 to 3 m.

25. The process according to embodiment 23 or 24, wherein the column has a diameter in the range of from 30 to 70 mm, preferably in the range of from 45 to 55 mm.

26. The process according to any one of embodiments 1 to 25, wherein heating the droplets obtained in (ii) according to (iii) comprises maintaining the droplets in suspense in a non-polar organic solvent, preferably by allowing the droplets to fall through the non-polar organic solvent system.

27. The process according to any one of embodiments 1 to 26, wherein the non-polar organic solvent system comprises an amount in the range of from 0 to 0.2 weight-%, preferably in the range of from 0 to 0.1 weight-%, of S, based on the weight of the non-polar organic solvent system, wherein the amount of S is preferably determined according to DIN EN ISO 14596.

28. The process according to any one of embodiments 1 to 27, wherein the non-polar organic solvent system has a density in the range of from 850 to 880 g/ml, preferably in the range of from 860 to 870 g/ml, wherein the density is preferably determined at a temperature of 20° C., wherein the density is preferably determined according to DIN 51757 test procedure 3 (German DIN 51757 Verf. 3).

29. The process according to any one of embodiments 1 to 28, wherein the non-polar organic solvent system has a kinetic viscosity in the range of from 4.8 to 5.6 mm²/s, preferably in the range of from 5.0 to 5.4 mm²/s, wherein the kinetic viscosity is preferably determined at a temperature of 100° C., wherein the kinetic viscosity is preferably determined according to DIN EN ISO 3104.

30. The process according to any one of embodiments 1 to 29, wherein the non-polar organic solvent system has a refractive index in the range of from 1.4763 to 1.4769, preferably in the range of from 1.4765 to 1.4767, wherein the refractive index is preferably determined at a temperature of 100° C., wherein the refractive index is preferably determined according to DIN 51423-02.

31. The process according to any one of embodiments 1 to 30, wherein the non-polar organic solvent system comprises an amount in the range of from 2 to 4 weight-%, preferably in the range of from 2.5 to 3.5 weight-%, of aromatic hydrocarbons, based on the weight of the non-polar organic solvent system, wherein the amount of aromatic hydrocarbons is preferably determined according to calculation method U of DIN 51378.

32. The process according to any one of embodiments 1 to 31, wherein the non-polar organic solvent system comprises an amount in the range of from 28 to 34 weight-%, preferably in the range of from 30 to 32 weight-%, of naphthenic hydrocarbons, based on the weight of the non-polar organic solvent system, wherein the amount of naphthenic hydrocarbons is preferably determined according to calculation method U of DIN 51378.

33. The process according to any one of embodiments 1 to 32, wherein the non-polar organic solvent system comprises an amount in the range of from 61 to 69 weight-%, preferably in the range of from 63 to 67 weight-%, of paraffinic hydrocarbons, based on the weight of the non-polar organic solvent system, wherein the amount of paraffinic hydrocarbons is preferably determined according to calculation method U of DIN 51378.

34. The process according to any one of embodiments 1 to 33, wherein the non-polar organic solvent system has a viscosity index in the range of from 97 to 103, preferably in the range of from 99 to 101, wherein the viscosity index is preferably determined according to DIN ISO 2909.

35. The process according to any one of embodiments 1 to 34, wherein heating the droplets obtained in (ii) according to (iii) comprises applying a flow of the non-polar organic solvent system opposite to the falling direction of the droplets.

36. The process according to any one of embodiments 1 to 35, further comprising after (iii) and prior to (iv) collecting the precursor particles in an aqueous solution S₁.

37. The process according to embodiment 36, wherein the pH of the aqueous solution S₁ is in the range of from 11.0 to 14.0, preferably in the range of from 12.0 to 13.7, more preferably in the range of from 13.0 to 13.5.

38. The process according to embodiment 36 or 37, wherein the precursor particles are collected in the aqueous solution S₁ in a column, wherein the precursor particles are more preferably collected in the same column in which the droplets obtained in (ii) are heated according to (iii).

39. The process according to any one of embodiments 36 to 38, wherein heating the droplets obtained in (ii) in a non-polar organic solvent system according to (iii) and collecting the droplets in an aqueous solution S₁ is performed in a column, wherein the column comprises-es the non-polar organic solvent system and the aqueous solution S₁,
wherein the droplets obtained in (ii) are heated according to (iii) prior to being collected in the aqueous solution S₁,
wherein the process preferably comprises allowing the droplets obtained in (ii) to pass through the non-polar-organic solvent system prior to being collected in the aqueous solution S₁.

40. The process according to any one of embodiments 1 to 39, wherein the precursor particles obtained in (iii) are heated in the aqueous solution S₂ according to (iv) in a vessel.

41. The process according to any one of embodiments 1 to 40, wherein the weight ratio of the precursor particles, calculated as sum of the weights of the precursor particles, to the aqueous solution S₂, calculated as weight of the aqueous solution S₂, in (iv) is in the range of from 1:2 to 1:20, preferably in the range of from 1:4 to 1:15, more preferably in the range of from 1:6 to 1:10.

42. The process according to any one of embodiments 1 to 41, wherein the aqueous solution S₂ comprises one or more of sodium aluminate (NaAlO₂), ammonia, and sodium hydroxide (NaOH), preferably sodium aluminate (NaAlO₂) and sodium hydroxide.

43. The process according to embodiment 42, wherein the aqueous solution S₂ comprises aluminum, in addition to the aluminum comprised in the precursor particles, calculated as Al₂O₃, in an amount in the range of from 3.00 to 6.50 g/l, preferably in the range of from 4.50 to 5.00 g/l, more preferably in the range of from 4.65 to 4.80 g/l.

44. The process according to embodiment 42 or 43, wherein the aqueous solution S₂ comprises sodium, in addition to the sodium optionally comprised in the precursor particles, calculated as Na, in an amount in the range of from 2.00 to 5.00 g/l, preferably in the range of from 3.40 to 3.80 g/l, more preferably in the range of from 3.55 to 3.65 g/l.

45. The process according to any one of embodiments 1 to 44, wherein the pH of the aqueous solution S₂ according to (iv) is in the range of from 12.2 to 13.9, preferably in the range of from 12.4 to 13.8, more preferably in the range of from 12.6 to 13.7, more preferably in the range of from 12.8 to 13.6, more preferably in the range of from 13.0 to 13.5, wherein the pH is preferably determined according to Reference Example 1.

46. The process according to any one of embodiments 1 to 45, wherein the precursor particles obtained in (iii) are heated according to (iv) to a temperature in the range of from 87 to 105° C., preferably in the range of from 89 to 102° C., more preferably in the range of from 90 to 100° C.

47. The process according to any one of embodiments 1 to 46, wherein the precursor particles obtained in (iii) are heated according to (iv) for a duration in the range of from 3 to 25 h, preferably in the range of from 4 to 20 h, more preferably in the range of from 5 to 17 h.

48. The process according to any one of embodiments 1 to 47, further comprising (v) separating the particulate alumina obtained in (iv) from the aqueous solution S₂, wherein separating preferably comprises filtration or centrifugation of the aqueous solution S₂.

49. The process according to any one of embodiments 1 to 48, further comprising (vi) washing the particulate alumina obtained in (iv) or (v) with a liquid solvent system, wherein the liquid solvent system preferably comprises one or more of water, an alcohol, and a mixture of two or more thereof, wherein the particulate alumina is more preferably washed with water, wherein the particulate alumina is more preferably washed with de-ionized water, wherein the particulate alumina is more preferably washed with de-ionized water until the conductivity of the washing water was less than 400 microS.

50. The process according to any one of embodiments 1 to 49, further comprising (vii) drying of the particulate alumina obtained in (iv), (v) or (vi) in a gas atmosphere.

51. The process according to embodiment 50, wherein the gas atmosphere in (vii) has a temperature in the range of from 90 to 130° C., preferably in the range of from 100 to 120° C., more preferably in the range of from 105 to 115° C.

52. The process according to embodiment 50 or 51, wherein the gas atmosphere in (vii) comprises one or more of oxygen and nitrogen, wherein the gas atmosphere in (vii) preferably is oxygen or air.

53. The process according to any one of embodiments 50 to 52, wherein the particulate alumina obtained in (iv), (v) or (vi) is dried in (vii) in an oven or in a belt dryer, preferably in a belt dryer.

54. The process according to any one of embodiments 50 to 53, wherein the particulate alumina obtained in (iv), (v) or (vi) is dried in (vii) for 1 to 5 h, preferably for 2 to 3 h.

55. The process according to any one of embodiments 1 to 54, further comprising (viii) pre-calcining of the particulate alumina obtained in (iv), (v), (vi) or (vii) in a gas atmosphere.

56. The process of embodiment 55, wherein the gas atmosphere in (viii) has a temperature in the range of from 400 to 460° C., preferably in the range of from 420 to 440° C., more preferably in the range of from 425 to 435° C.

57. The process according to embodiment 55 or 56, wherein pre-calcining according to (viii) comprises heating of the gas atmosphere with a heating ramp of 3 to 7 K/min, preferably of 4 to 6 K/min.

58. The process according to any one of embodiments 55 to 57, wherein the gas atmosphere in (viii) comprises one or more of oxygen and nitrogen, wherein the gas atmosphere in (viii) preferably is oxygen or air.

59. The process according to any one of embodiments 55 to 58, wherein the particulate alumina obtained in (iv), (v), (vi) or (vii) is pre-calcined in (viii) in a rotary calciner.

60. The process according to any one of embodiments 55 to 59, wherein the particulate alumina obtained in (iv), (v), (vi) or (vii) is pre-calcined in (viii) for 0.25 to 2 h, preferably for 0.5 to 1 h.

61. The process according to any one of embodiments 1 to 60, further comprising (ix) calcining of the particulate alumina obtained in (iv), (v), (vi), (vii) or (viii) in a gas atmosphere.

62. The process of embodiment 61, wherein the gas atmosphere in (ix) has a temperature in the range of from 900 to 1050° C., preferably in the range of from 940 to 980° C., more preferably in the range of from 945 to 975° C.

63. The process according to embodiment 61 or 62, wherein calcining according to (ix) comprises heating of the gas atmosphere with a heating ramp of 3 to 7 K/min, preferably of 4 to 6 K/min.

64. The process according to any one of embodiments 61 to 63, wherein the gas atmosphere in (ix) comprises one or more of oxygen and nitrogen, wherein the gas atmosphere in (ix) preferably is oxygen or air.

65. The process according to any one of embodiments 61 to 64, wherein the particulate alumina obtained in (iv), (v), (vi), (vii) or (viii) is calcined in (ix) in a rotary calciner.

66. The process according to any one of embodiments 61 to 65, wherein the particulate alumina obtained in (iv), (v), (vi), (vii) or (viii) is calcined in (ix) for 0.25 to 2 h, preferably for 0.5 to 1 h.

67. A particulate alumina as obtained and/or obtainable by the process according to any one of embodiments 1 to 66.

68. The particulate alumina according to embodiment 67, having a side crushing strength in the range of from 9 to 25 N/mm, preferably in the range of from 10 to 19 N/mm, more preferably in the range of from 11 to 18 N/mm, more preferably in the range of from 12 to 17 N/mm, preferably determined according to Reference example 2.

69. The particulate alumina according to embodiment 67 or 68, having a particle diameter in the range of from 2.0 to 3.0 mm, preferably in the range of from 2.5 to 3.0 mm, preferably according to Reference example 6.

70. The particulate alumina according to any one of embodiments 67 to 69, having a packed apparent bulk density in the range of from 0.45 to 0.55 g/cm³, preferably in the range of from 0.48 to 0.52 g/cm³, more preferably in the range of from 0.49 to 0.51 g/cm³, preferably determined according to Reference example 3.

71. The particulate alumina according to any one of embodiments 67 to 70, comprising an amount of Na, calculated as elemental Na, in the range of from 0 to 25000 ppm, preferably in the range of from 0 to 20000 ppm, preferably determined according to Reference Example 8.

72. The particulate alumina according to any one of embodiments 67 to 71, having a BET specific surface area in the range of from 30 to 150 m²/g, preferably in the range of from 40 to 140 m²/g, preferably determined according to Reference Example 4.

73. The particulate alumina according to any one of embodiments 67 to 72, having a total pore volume in the range of from 0.5 to 1.5 ml/g, preferably in the range of from 0.7 to 1.3 ml/g, more preferably in the range of from 0.8 to 1.2 ml/g, preferably determined according to Reference Example 5.

74. The particulate alumina according to any one of embodiments 67 to 73, having a relative particle attrition in the range of from 0 to 2 weight-%, preferably determined according to Reference Example 9.

75. The particulate alumina according to any one of embodiments 67 to 74, being in the form of a sphere.

76. A particulate alumina having a side crushing strength in the range of from 9 to 25 N/mm and a packed apparent bulk density in the range of from 0.45 to 0.55 g/cm³, wherein the side crushing strength is preferably determined according to Reference Example 2, and wherein the packed apparent bulk density is preferably determined according to Reference Example 3.

77. The particulate alumina according to embodiment 76, having a side crushing strength in the range of from 10 to 19 N/mm, preferably in the range of from 11 to 18 N/mm, more preferably in the range of from 12 to 17 N/mm, preferably determined according to Reference example 2.

78. The particulate alumina according to embodiment 76 or 77, having a particle diameter in the range of from 2.0 to 3.0 mm, preferably in the range of from 2.5 to 3.0 mm, preferably according to Reference example 6.

79. The particulate alumina according to any one of embodiments 76 to 78, having a packed apparent bulk density in the range of from 0.48 to 0.52 g/cm³, more preferably in the range of from 0.49 to 0.51 g/cm³, preferably determined according to Reference example 3.

80. The particulate alumina according to any one of embodiments 76 to 79, comprising an amount of Na, calculated as elemental Na, in the range of from 0 to 25000 ppm, preferably in the range of from 0 to 20000 ppm.

81. The particulate alumina according to any one of embodiments 76 to 80, having a BET specific surface area in the range of from 30 to 150 m²/g, preferably in the range of from 40 to 140 m²/g, preferably determined according to Reference Example 4.

82. The particulate alumina according to any one of embodiments 76 to 81, having a total pore volume in the range of from 0.5 to 1.5 ml/g, preferably in the range of from 0.7 to 1.3 ml/g, more preferably in the range of from 0.8 to 1.2 ml/g, preferably determined according to Reference Example 5.

83. The particulate alumina according to any one of embodiments 76 to 82, having a relative particle attrition in the range of from 0 to 2 weight-%, preferably determined according to Reference Example 9.

84. The particulate alumina according to any one of embodiments 76 to 83, being in the form of a sphere.

85. Use of an particulate alumina according to any one of embodiments 67 to 84 as a catalyst or catalyst support, preferably as a catalyst support for a metal selected from the group consisting of Fe, Ru, Os, Co, Rh, Ir, Ni, Pd, Pt, Cu, Ag, Au, and a mixture of two or more thereof, more preferably as a catalyst support for a metal selected from the group consisting of Pd, Ag, and a mixture thereof.

The present invention is further illustrated by the following reference examples, examples, and comparative examples.

### Examples

### Reference Example 1: Determination of the pH Value

The pH was measured with pH 3310 pH meter from WTW. Prior to each usage, the pH elec-trode was calibrated at room temperature using standard solutions for calibration with pH=7 and pH=10 respectively. The pH of starting solutions was measured at room temperature. To moni-tor the pH during the synthesis, samples were repeatedly taken and measured at room temperature The temperature dependence of the pH values is taken into consideration.

### Reference Example 2: Determination of the Side Crushing Strength

Side crushing strength is determined by placing a spheroidal particle between two parallel plates of a testing machine such as the Schleuniger 6D, manufactured by Schleuniger Pharmatron, Inc. The amount of force required to crush the particle is measured in Newton. A sufficient number of particles (35) is crushed in order to get a statistically significant estimate for the total population. The average is calculated from the individual results. The amount of force required to crush the particle may be converted to N/mm by dividing the amount of force required to crush the particle with the size of the particle measured as described under Reference Example 6.

### Reference Example 3: Determination of the Packed Apparent Bulk Density

The packed apparent bulk density was determined on a Dr. Schleuniger Pharmatron AG Tapped Density Tester JV-2000.

### General Description of the Determination Method:

A graduated cylinder is filled with the sample in 5 steps for a total of 250 ml of the sample. 200 taps are made after each fill step. Finally, another 200 taps are made. A packed catalyst bed is hereby obtained. When the graduated cylinder is filled, the volume is read and the net weight of the graduated cylinder is determined. The weight/volume ratio is the PABD.

### Detailed Determination Method:

1. Determine the tare weight, accurate to 0.1 gram, of the graduated cylinder (T in grams).
2. Fill the graduated cylinder with approximately 50 ml of sample.
3. Place the graduated cylinder on the stamp and secure it with the appropriate bayonet fit-ting.
4. If necessary, use the function key to select the appropriate method.
5. Enter 200 using the numeric keys for setting the number of tabs.
6. Press start. Then, 200 taps are applied.
7. Fill the graduated cylinder with additional 50 ml of sample and press start (tap 200 more times).
8. Repeat step 7 3 more times (total 5 fills and 1000 taps).
9. Then, tap another 200 times, for a total of 1200 taps.
10. Read the final volume (V ml).
11. Determine the weight of the filled cylinder (G in grams).
12. Calculate the packed apparent bulk density according to the following formula: PABD=(G-T)/V.

### Reference Example 4: Determination of the BET Specific Surface Area

The BET specific surface area was determined via nitrogen physisorption at 77 K according to the method disclosed in ISO 9277:2010.

### Reference Example 5: Determination of the Total Pore Volume

The total pore volume was determined via intrusion mercury porosimetry according to standard ASTM D 4284-12.

### Reference Example 6: Determination of the Particle Diameter

The particle diameter was determined with a sliding micro-meter device.

### Reference Example 7: Determination of the Volume-Based Particle Size Distribution

The volume-based particle size distribution (PSD) was measured on a sample in the form of a powder. It is measured by laser diffraction with a Malvern mastersizer apparatus. First, a sample was dispersed in water. For the measurement, the sample was then put into a measurement chamber. The intensity of the scattered light is than measured by a detector, and from the intensity the particle size distribution is then calculated. (Malvern Panalytical, 2019)

### Reference Example 8: Determination of Na Content

The determination of the Na content of a sample was performed on an iCE3000AA atomic absorption spectrometer (Thermo Scientific).

### General Description of the Determination Method:

After a metal has been put into solution, this solution is atomized in a flame. The metal absorbs part of a light wavelength specific to it, which is emitted by a hollow cathode lamp specific to the element. The amount of light absorbed is measured using a photomultiplier and is a measure of the concentration. In addition to absorption, emissions can also be measured with this device. The emitted radiation from the element to be measured is measured with the photomultiplier. A radiation buffer is added to prevent ionization.

### Calibration Method:

1. The AAS calibration is made using a 10 mg/L sodium solution as reference. Said reference solution is made from a certified standard of 1000 ppm sodium.
2. Measuring the reference solution according to the method described below. The reference measurement is performed after every 5 measurements.

### Drawing Up Calibration Curve for the Determination of Sodium:

1. Set up a calibration curve according to the following table, based on 1000 mg/l Na stock solution.

| Concentration Na | Pipetting | volumetric flask | conc. HNO3 |
|---|---|---|---|
| mg/l calibration curve | [ml] | [ml] | [ml] |
| 0.00 | 0 | 1000 | 100 |
| 10.00 | 10 | 1000 | 100 |
| 20.00 | 20 | 1000 | 100 |
| 40.00 | 40 | 1000 | 100 |

2. Fill the flask with demineralized water and homogenize.
3. Enter the default line according to the procedure described. As noted above, the calibration standard is 10 mg/l.

### Detailed Determination Method:

1. Switching on the equipment and open the acetylene and air valves.
2. In the gas chamber, the pressure for acetylene is set at 0.75 bar.
3. The air pressure on the panel is set to 2.9 bar
4. Turn on the spectrometer
5. Start the software
7. Turn on the lamp
8. Choose correct lamp in the menu and set state to ON. Let the lamp stabilize for half an hour.
9. Select analysis method
10. Create a new result file
11. Check the burner height. When switching on the apparatus, the burner height will be approx. 16.3 mm. Set the burner height to approx. 7 mm with the knob
12. Open the burner compartment with the rotary knob on the right.
13. Check with the block whether the light beam radiates tightly over the burner opening.
14. If necessary, correct the lateral adjustment by turning the left knob on the outside near the suction hose. To do this, the door must be closed. The button must be pressed to rotate.
15. Remove the block from the burner
16. Close the burner compartment and check if the white button on the left is flashing.
17. Ignite the flame by briefly pressing the white knob on the left side until the burner is lit.
18. Start the method, followed by analysis.
19. When measuring with AAS, start with demineralized water. The apparatus adjusts the height of the burner itself.
20. Continue to follow the instructions on the screen.
21. After the measurement, turn off the burner with the red button on the left side of the device.
22. Turn off the lamp, close the gas taps.

### Reference Example 9: Determination of Relative Particle Attrition

The attrition was determined according to ASTM D4058-7.

An Abrasion Resistance Rotab AS/S was used with a drum equipped with a baffle and a sieve with 20 mesh (0.850 mm).

### Detailed Description of the Determination:

1. Open the door of the Rotab and unscrew the drum
2. Weigh approximately 100 grams of a sample in a 600 ml beaker in a powder cabinet
3. Carefully sieve this sample to remove any “fines” that may be present
4. Weigh the sample to the nearest 0.01 gram (A in grams)
5. Place the sample in the baffle drum and close it. Make sure that the 8 bolts are tightened crosswise. It is also important that the bolts are properly tightened. This ensures that no powder is released during turning
6. Open the door of the Rotab and place the drum. Make sure that the opening of the drum falls exactly on the rotating shaft. With the help of the special wrench, the screw on the drum is tightened. Close the door. The counter is set to 1800 by default. The top line must be set to 0. The rotation speed is set to 60 rpm by default
7. After 30 minutes, remove the sample from the drum and sieve it on a 20 mesh sieve. Use nitrile gloves and sleeve protectors
8. Weigh the material that remains on the sieve in a powder cabinet, to the nearest 0.01 gram (B in grams)
9. The attrition in % is calculated according to the following formula: (A-B)/A*100

### Example 1: Process for the Preparation of Particulate Alumina

In a vessel, 655 g de-ionized water were cooled to 5° C. Then, 740 g alumina (rho-alumina, amorphous Al₂O₃·0.5 H₂O; being ball-milled to have a volume-based particle size D50 of 5 micrometer) were added under stirring with a helix stirrer at 250 rpm to give a mixture comprisessing 52.5 weight-% of the alumina. The alumina was added within about 30 minutes. The resulting slurry was stirred overnight. The slurry then had a viscosity of about 800 mPa·s.

For the formation of droplets a vibrating nozzle was used. Said vibrating nozzle effected a laminar jet break-up mechanism to generate droplets from the slurry.

The droplets formed by dispersing the slurry through the nozzle fell through the air for about 10 cm in oil comprised in a forming tower. Said forming tower comprised a steel column having a total length of 3 m and a diameter of 50 mm. The forming tower was filled with oil over a length of the column of 2.5 m and with water over a length of the column of 0.5 m. Thus, the column comprised an oil phase and a water phase. The oil phase was heated to a temperature of 90° C. Further, a counter-flow of the oil was established to the falling direction of the precursor particles. For doing so, a sinus-pump was used. The residence time of the droplets in the oil was about 21 s. During said time, precursor particles formed. Then, the precursor particles were collected in the water phase, wherein the pH of the water phase was adjusted to 11 by addition of NaOH.

The collected precursor particles were then transported in a water stream into a collecting vessel. The precursor particles were then aged in said collecting vessel. To this effect, the pH of the mixture comprising water and the precursor particles was adjusted to 13 by addition of sodium aluminate (NaAlO₂). The weight ratio of the precursor particles to water was 1:8. The mixture was then heated to a temperature of 100° C. and the precursor particles were aged at said temperature overnight.

The obtained particulate alumina were then washed with de-ionized water. Subsequently, the washed particulate alumina was dried in air in an oven at 110° C. for 2 to 3 hours. Finally, the dried particulate alumina was calcined in air in an oven according to the program outlined in table 1 below.

TABLE 1
Calcination program for calcining the obtained particulate alumina.

| | |
|---|---|
| Temperature | Hold |

| | | | | |
|---|---|---|---|---|
| Target | 110° | C. | 5 | h |
| Heating ramp | 5° | C./min | | |
| Target | 430° | C. | 0.75 | h |
| Heating ramp | 5° | C./min | | |
| Target | 970° | C. | 0.75 | h |

The resulting particulate alumina had an average particle diameter of 2.7 mm, a side crushing strength of 44 N (N/particle averaged for 35 alumina particles), a packed apparent bulk density of 0.50 g/ml, a Na content of 12500 ppm, a BET specific surface area of 136 m2/g, and a total pore volume of 0.86 ml/g.

TABLE 2
Pore Distribution of Example 1 measured
according to Reference Example 5.

| Average Pore | Incremental Pore | Cumulative Pore |
|---|---|---|
| Diameter [Å] | Volume [cm³/g] | Volume [cm³/g] |
| 2588.4 | 0.008056 | 0.008056 |
| 2109.4 | 0.008399 | 0.016455 |
| 1771.4 | 0.008882 | 0.025337 |
| 1523 | 0.008379 | 0.033716 |
| 1229.2 | 0.017982 | 0.051698 |
| 941 | 0.024972 | 0.07667 |
| 783.5 | 0.014744 | 0.091415 |
| 711.4 | 0.008586 | 0.100001 |
| 640.4 | 0.018083 | 0.118084 |
| 584.9 | 0,.009001 | 0.127085 |
| 531.4 | 0.018529 | 0.145614 |
| 472.1 | 0.019635 | 0.165249 |
| 421.9 | 0.020123 | 0.185372 |
| 378.1 | 0.019845 | 0.205217 |
| 338.9 | 0.020275 | 0.225492 |
| 306.6 | 0.019545 | 0.245038 |
| 279.1 | 0.019264 | 0.264302 |
| 248.1 | 0.029524 | 0.293825 |
| 222.1 | 0.022179 | 0.316005 |
| 196.6 | 0.035273 | 0.351278 |
| 172.2 | 0.033639 | 0.384916 |
| 154.1 | 0.026345 | 0.411262 |
| 136.7 | 0.033999 | 0.445261 |
| 121.7 | 0.023666 | 0.468928 |
| 110.2 | 0.019673 | 0.488601 |
| 97.3 | 0.02484 | 0.513441 |
| 86.1 | 0.015111 | 0.528552 |
| 75.4 | 0.016806 | 0.545358 |
| 64.5 | 0.013377 | 0.558735 |
| 55.2 | 0.009381 | 0.568116 |
| 48.1 | 0.005655 | 0.573771 |
| 42.5 | 0.003954 | 0.577725 |
| 37.8 | 0.002886 | 0.580611 |
| 33.7 | 0.002144 | 0.582754 |
| 30.2 | 0.001625 | 0.584379 |
| 27 | 0.001186 | 0.585565 |
| 24.3 | 0.000769 | 0.586334 |
| 21.7 | 0.000421 | 0.586755 |
| 20 | 0.000057 | 0.586812 |
| 19 | 0.00001 | 0.586821 |

### Example 2: Process for the Preparation of Particulate Alumina

Example 1 was repeated with the exception that the pH of the mixture comprising water and the precursor particles for aging was adjusted to 13.5 (instead of 13).

The resulting particulate alumina had an average particle diameter of 2.7 mm, a side crushing strength of 51 N (N/particle averaged for 35 alumina particles), a packed apparent bulk density of 0.51 g/ml, a Na content of 18411 ppm, a BET specific surface area of 121 m²/g, and a total pore volume of 0.83 ml/g.

TABLE 3
Pore Distribution of Example 2 measured
according to Reference Example 5.

| Average Pore | Incremental Pore | Cumulative Pore |
|---|---|---|
| Diameter [Å] | Volume [cm³/g] | Volume [cm³/g] |
| 2760.7 | 0.015625 | 0.015625 |
| 2221.5 | 0.007841 | 0.023466 |
| 1897.4 | 0.008123 | 0.031589 |
| 1635.9 | 0.007419 | 0.039008 |
| 1242.6 | 0.026438 | 0.065446 |
| 951.9 | 0.023668 | 0.089115 |
| 813.1 | 0.013534 | 0.102649 |
| 724.4 | 0.015026 | 0.117674 |
| 643.4 | 0.017875 | 0.135549 |
| 592.5 | 0.008867 | 0.144416 |
| 541.9 | 0.018904 | 0.16332 |
| 486.8 | 0.017631 | 0.180951 |
| 426.1 | 0.026754 | 0.207705 |
| 376 | 0.019611 | 0.227316 |
| 339.6 | 0.019498 | 0.246814 |
| 308.2 | 0.018918 | 0.265731 |
| 280.8 | 0.018531 | 0.284262 |
| 249.2 | 0.029035 | 0.313297 |
| 222.2 | 0.021079 | 0.334377 |
| 195.5 | 0.03175 | 0.366127 |
| 172.4 | 0.024835 | 0.390962 |
| 155.8 | 0.019832 | 0.410794 |
| 137.6 | 0.02762 | 0.438414 |
| 121.6 | 0.019473 | 0.457887 |
| 110.2 | 0.013666 | 0.471553 |
| 97.2 | 0.01993 | 0.491483 |
| 85.1 | 0.013549 | 0.505033 |
| 74.9 | 0.012221 | 0.517253 |
| 64 | 0.012294 | 0.529547 |
| 55 | 0.007662 | 0.537209 |
| 48.2 | 0.005411 | 0.542619 |
| 42.5 | 0.00386 | 0.546479 |
| 37.8 | 0.002723 | 0.549203 |
| 33.8 | 0.002013 | 0.551216 |
| 30.2 | 0.001551 | 0.552767 |
| 27.1 | 0.001092 | 0.553859 |
| 24.3 | 0.000755 | 0.554614 |
| 21.7 | 0.000574 | 0.555187 |
| 20 | 0.000179 | 0.555367 |
| 19.1 | 0.000183 | 0.555549 |
| 18.1 | 0.000174 | 0.555723 |

### Example 3: Process for the Preparation of Particulate Alumina

Example 1 was repeated with the exception that during aging the mixture was heated to a temperature of 95° C.

The resulting particulate alumina had an average particle diameter of 2.77 mm, a side crushing strength of 79.9 N (N/particle averaged for 35 alumina particles), a Na content of 2120 ppm, a BET specific surface area of 150 m²/g, and a total pore volume of 0.87 ml/g.

TABLE 4
Pore Distribution of Example 3 measured
according to Reference Example 5.

| Average Pore | Incremental Pore | Cumulative Pore |
|---|---|---|
| Diameter [Å] | Volume [cm³/g] | Volume [cm³/g] |
| 2831.3 | 0.005708 | 0.005708 |
| 2234.2 | 0.00759 | 0.013299 |
| 1815.3 | 0.007235 | 0.020533 |
| 1287.5 | 0.019444 | 0.039977 |
| 928.8 | 0.019289 | 0.059266 |
| 776.9 | 0.008825 | 0.068092 |
| 651.9 | 0.0185 | 0.086592 |
| 524.9 | 0.024655 | 0.111246 |
| 415.4 | 0.035228 | 0.146474 |
| 346.3 | 0.026761 | 0.173235 |
| 303.6 | 0.02445 | 0.197685 |
| 255.4 | 0.048742 | 0.246427 |
| 218.4 | 0.036113 | 0.28254 |
| 157.8 | 0.121529 | 0.404069 |
| 117.7 | 0.071264 | 0.475333 |
| 80.5 | 0.079265 | 0.554598 |
| 58 | 0.027894 | 0.582492 |
| 44.6 | 0.010803 | 0.593295 |
| 35.1 | 0.0048 | 0.598095 |
| 28.1 | 0.00164 | 0.599735 |
| 24.3 | 0.000142 | 0.599877 |

### Comparative Example 3: Process for the Preparation of Particulate Alumina According to the Prior Art

Example 1 was repeated with the exception that the pH of the mixture comprising water and the precursor particles for aging was adjusted to 11 (instead of 13).

The resulting particulate alumina had an average particle diameter of 2.7 mm, a side crushing strength of 18.4 N (N/particle averaged for 35 alumina particles), a packed apparent bulk density of 0.47 g/ml, a Na content of 410 ppm, a BET specific surface area of 122 m²/g, and a total pore volume of 0.96 ml/g.

### Comparative Example 4: Process for the Preparation of Particulate Alumina According to the Prior Art

Example 1 was repeated with the exception that the pH of the mixture comprising water and the precursor particles for aging was adjusted to 7 (instead of 13).

The resulting particulate alumina had an average particle diameter of 2.8 mm, a side crushing strength of 18.8 N (N/particle averaged for 35 alumina particles), a packed apparent bulk density of 0.49 g/ml, a Na content of 2180 ppm, a BET specific surface area of 128 m²/g, and a total pore volume of 0.95 ml/g.

As can be seen from Examples 1-2 in accordance with the present invention, the inventive process allows for the preparation of particulate alumina having an excellent physical integrity, specifically shown by a comparatively high side crushing strength.

### CITED LITERATURE

US 7,090,825 B2
US 4,065,407 A
US 4,169,874 A
US 6,197,073 B1
US 4,318,896 A
US 4,542,113 A
EP 0153674 A2
US 3,223,483 A
US 4,279,779 A
US 4,411,771 A
US 4,315,839 A
US 10,232,346 B2
US 4,390,456 A

1.-15. (canceled)

16. A process for the preparation of particulate alumina, comprising:
(i) preparing a mixture comprising water and one or more sources of alumina;
(ii) spraying the mixture obtained in (i) for forming droplets;
(iii) heating the droplets obtained in (ii) in a non-polar organic solvent system, to a temperature in the range of from 85 to 100° C., to obtain precursor particles;
(iv) heating the precursor particles obtained in (iii) in an aqueous solution S₂ to a temperature in the range of from 85 to 110° C., wherein the pH of the aqueous solution S₂ is in the range of from 12 to 14, to obtain particulate alumina.

17. The process according to claim 16, wherein the total amount of the one or more sources of alumina in the mixture obtained in (i) calculated as Al₂O₃ is in the range of from 40 to 65 weight-%, based on the weight of the mixture obtained in (i).

18. The process according to claim 16, wherein the one or more sources of alumina comprise one or more of aluminum trihydroxide, Al₂O₃·0.5 H₂O, rho-alumina, and sodium aluminate.

19. The process according to claim 16, wherein the mixture obtained in (i) is sprayed in (ii) by means of a nozzle.

20. The process according to claim 16, wherein heating the droplets obtained in (ii) according to (iii) comprises maintaining the droplets in suspense in a non-polar organic solvent.

21. The process according to claim 16, further comprising after (iii) and prior to (iv) collecting the precursor particles in an aqueous solution S₁.

22. The process according to claim 21, wherein the pH of the aqueous solution S₁ is in the range of from 11.0 to 14.0.

23. The process according to claim 21, wherein heating the droplets obtained in (ii) in a non-polar organic solvent system according to (iii) and collecting the droplets in an aqueous solution S₁ is performed in a column, wherein the column comprises the non-polar organic solvent system and the aqueous solution S₁,
wherein the droplets obtained in (ii) are heated according to (iii) prior to being collected in the aqueous solution S₁.

24. The process according to claim 16, wherein the weight ratio of the precursor particles, calculated as sum of the weights of the precursor particles, to the aqueous solution S₂, calculated as weight of the aqueous solution S₂, in (iv) is in the range of from 1:2 to 1:20.

25. A particulate alumina obtained by the process according to claim 16.

26. A particulate alumina having a side crushing strength in the range of from 9 to 25 N/mm and a packed apparent bulk density in the range of from 0.45 to 0.55 g/cm³.

27. The particulate alumina according to claim 26, having a particle diameter in the range of from 2.0 to 3.0 mm.

28. The particulate alumina according to claim 26, having a BET specific surface area in the range of from 30 to 150 m²/g.

29. The particulate alumina according to claim 26, having a total pore volume in the range of from 0.7 to 1.5 ml/g.

30. A catalyst or catalyst support comprising the particulate alumina according to claim 25.
